(19) United States
(12) Patent Application Publication
(10) Pub. No.: US 2026/0347180 A1
(43) Pub. Date: Nov. 5, 2026

(54) IODINE RECOVERY METHOD AND APPARATUS

(71) Applicants: SK INNOVATION CO., LTD., Seoul (KR); SK ON CO., LTD., Seoul (KR)

(72) Inventors: Jae Hun JEONG, Daejeon (KR); Soo Kil KANG, Daejeon (KR); Hee Du LEE, Daejeon (KR)

(21) Appl. No.: 19/638,053

(22) Filed: Apr. 2, 2026

(30) Foreign Application Priority Data
Apr. 30, 2025 (KR) 10-2025-0057701
Aug. 29, 2025 (KR) 10-2025-0122230

(51) Int. Cl. C01B 7/14; B01D 5/00

(52) U.S. Cl. CPC C01B 7/14; B01D 5/0072

(57) ABSTRACT

An iodine recovery apparatus according to an embodiment of the present disclosure may include: a main chamber containing a main solvent; and an inlet pipe connected to the main chamber, the inlet pipe being configured to introduce iodine in a gaseous state into the main chamber. The main chamber may be configured so that the iodine in a gaseous state is cooled upon contact with the main solvent and precipitated as solid iodine. Also disclosed is an iodine recovery method including: introducing gaseous iodine into a main chamber containing a main solvent; and cooling the gaseous iodine upon contact with the main solvent to precipitate the iodine as solid iodine.

### CROSS-REFERENCE TO RELATED APPLICATION

This patent application claims the priority and benefits of Korean patent application No. 10-2025-0057701, filed on Apr. 30, 2025 and Korean patent application No. 10-2025-0122230, filed on Aug. 29, 2025, the disclosure of which is incorporated herein by reference in its entirety.

### BACKGROUND OF THE INVENTION

### 1. Field of the Invention

The present disclosure relates to an iodine recovery method and an iodine recovery apparatus.

### 2. Description of the Related Art

Iodine is a high-value substance used in various chemical processes. Research is being conducted on techniques for recovering iodine from a mixed gas generated after a reaction.

Typically, to recover iodine from a mixed gas, a method of precipitating (desublimating) iodine into a solid state through cooling is used.

In such a method, precipitated iodine may adhere to inner walls of an apparatus, which may result in pipe clogging, reduced heat transfer, and process interruptions. In particular, if solid iodine accumulates beyond a certain thickness, the above-described problems may be exacerbated, thereby making continuous process operation difficult.

### SUMMARY OF THE INVENTION

An object of the present disclosure is to provide an apparatus and a method for separating and recovering iodine from a gas mixture.

An iodine recovery apparatus according to some embodiments of the present disclosure may include: a main chamber containing a main solvent; and an inlet pipe connected to the main chamber, the inlet pipe may be configured to introduce iodine in a gaseous state into the main chamber, wherein the main chamber may be configured so that the iodine in a gaseous state is cooled upon contact with the main solvent and precipitated as solid iodine.

In some embodiments, the iodine recovery apparatus may further include a separation chamber configured to: receive the solid iodine and the main solvent discharged from the main chamber; and separate the solid iodine from the main solvent.

In some embodiments, the iodine recovery apparatus may further include a circulation pipe configured to supply the main solvent separated in the separation chamber to the main chamber.

In some embodiments, the iodine recovery apparatus may further include a cooler connected to the circulation pipe, the cooler may be configured to cool the main solvent supplied to the main chamber from the separation chamber.

In some embodiments, the cooler may be configured to cool the main solvent supplied to the main chamber to a temperature of 50° C. or lower.

In some embodiments, the separation chamber may further comprise a filter, the filter being configured to allow the main solvent introduced into the separation chamber to pass therethrough and prevent the solid iodine from passing therethrough.

In some embodiments, an end portion of the inlet pipe may be positioned within the main chamber.

In some embodiments, a portion of the inlet pipe disposed within the main chamber may include gas discharge holes configured to discharge a gas mixture containing the iodine in a gaseous state.

In some embodiments, the inlet pipe may comprise a plurality of the gas discharge holes.

In some embodiments, spacings between the plurality of gas discharge holes may be different from each other.

In some embodiments, the spacing between the plurality of gas discharge holes may decrease toward an end of the inlet pipe.

In some embodiments, the inlet pipe may further comprise a bubble generator configured to form bubbles of the gas mixture containing the iodine in a gaseous state introduced into the main chamber.

In some embodiments, the iodine recovery apparatus may be further configured so that a temperature of the gas mixture introduced through the inlet pipe is in a range of 150° C. to 250° C.

In some embodiments, the separation chamber may be further configured to heat the main solvent and the solid iodine introduced into the separation chamber, thereby separating the main solvent and the solid iodine from each other.

In some embodiments, the separation chamber may be further configured to distill the main solvent introduced into the separation chamber through the heating of the main solvent and the solid iodine.

In some embodiments, the separation chamber may be further configured to heat the main solvent and the solid iodine such that the solid iodine is converted into liquid iodine; and the separation chamber further comprises a liquid-liquid separator configured to receive the main solvent and the liquid iodine introduced into the separation chamber and subject the main solvent and the liquid iodine to liquid-liquid separation, thereby recovering the liquid iodine.

An iodine recovery method according to some embodiments of the present disclosure may include: introducing gaseous iodine into a main chamber containing a main solvent; and cooling the gaseous iodine upon contact with the main solvent to precipitate the iodine as solid iodine.

In some embodiments, the iodine recovery method may further include: transferring the solid iodine and the main solvent discharged from the main chamber into a separation chamber; and separating the solid iodine from the main solvent in the separation chamber.

In some embodiments, the gaseous iodine may be introduced into the main chamber as a gas mixture including the gaseous iodine, and the gas mixture may be introduced into the main chamber as bubbles.

In some embodiments, the iodine recovery method may further include cooling the main solvent after separating the solid iodine from the main solvent, and supplying the cooled main solvent to the main chamber.

According to an embodiment of the present disclosure, a gas mixture may come into contact with a low-temperature main solvent, and thus gaseous iodine included in the gas mixture may be precipitated. Accordingly, the amount of iodine discharged without being precipitated may be reduced, thereby increasing an iodine recovery rate.

In addition, according to an embodiment of the present disclosure, iodine in a liquid state or a solid state may be discharged together with the main solvent and may not accumulate within the main chamber. Accordingly, a continuous process may be performed and maintenance may be facilitated. Furthermore, clogging of the inlet pipe through which the gas mixture is introduced or a reduction in heat transfer efficiency may be prevented.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a conceptual diagram of an iodine recovery apparatus according to an embodiment of the present disclosure;

FIG. 2 is a block diagram illustrating connection relationships between some components constituting the iodine recovery apparatus according to an embodiment of the present disclosure;

FIG. 3 is a flowchart illustrating an operating sequence of each component of the iodine recovery apparatus according to an embodiment of the present disclosure;

FIG. 4 is a flowchart illustrating an iodine recovery method according to an embodiment of the present disclosure;

FIG. 5 is a flowchart illustrating a precipitation step shown in FIG. 4; and

FIG. 6 is a flowchart illustrating an iodine recovery method according to another embodiment of the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe the invention, they should be interpreted based on the meanings and concepts that meet the technical spirit of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “have,” and the like should be interpreted in a non-exclusive manner. Unless explicitly stated otherwise, these terms should be construed to imply that the presence of the corresponding component, and not to exclude but rather include other components.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected,” “coupled,” or the like to another component, the component may be directly connected or coupled to the other component, but it may be “connected” or “coupled” to the other component with another component possibly interposed.

Space-related terms such as “beneath,” “below,” “lower,” “above,” “upper,” and the like may be used to aid in the understanding of the relationship between an element or feature and another illustrated in the drawings. These space-related terms are provided to aid in the understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present invention will not be described.

Hereinafter, an iodine recovery apparatus according to an embodiment of the present disclosure will be described in detail with reference to the accompanying drawings.

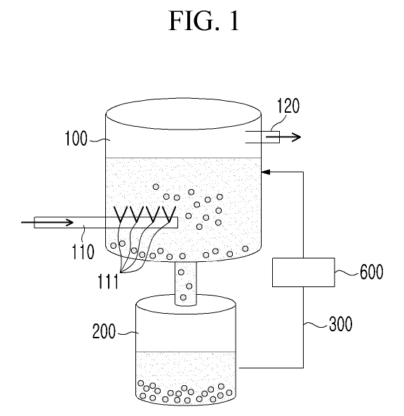

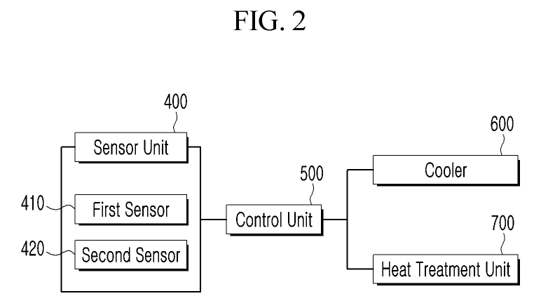

Referring to FIGS. 1-3, the iodine recovery apparatus according to an embodiment of the present disclosure may include a main chamber 100 and a separation chamber 200.

The main chamber 100 may accommodate a main solvent.

The main solvent may be a liquid-phase substance.

For example, the main solvent may be a non-polar solvent. For example, the main solvent may be any one of toluene, benzene, hexane, ether, kerosene, or a mixture thereof.

The gas mixture may include a hydrogen halide, such as hydrogen fluoride (HF) or hydrogen iodide (HI). When the main solvent is a polar solvent, some components of the gas mixture may react with the main solvent or dissolve in the main solvent, thereby forming a highly corrosive solution. In this case, problems such as damage to the main chamber 100 may occur.

For example, the main solvent may include a polar solvent that does not react with, or has a weak reactivity with, hydrogen halides included in the gas mixture. For example, the main solvent may include ethanol or chloroform.

For example, the main solvent may be a solution having a boiling point of 100° C. or lower. As will be described in detail below, when distilling a discharge solution including the main solvent to recover the precipitated iodine, if the boiling point of the main solvent is high, a high temperature, and by extension a large amount of energy, may be required during the distillation process.

An inlet pipe 110 through which gaseous iodine is introduced may be connected to the main chamber 100. Gaseous iodine may be introduced into the main chamber 100 through the inlet pipe 110. Alternatively, a gas mixture including gaseous iodine may be introduced into the main chamber 100 through the inlet pipe 110.

Hereinafter, a gas mixture including gaseous iodine will be described as being introduced into the main chamber 100. However, it will be understood that only gaseous iodine, rather than a gas mixture, may alternatively be introduced.

The inlet pipe 110 may be disposed below the center of the main chamber 100 in the vertical direction of the main chamber 100. For example, the inlet pipe 110 may be disposed at a position lower than the liquid level of the main solvent contained in the main chamber 100. For example, an end of the inlet pipe 110 may be submerged within the main solvent.

The gas mixture may flow through the inlet pipe 110 and be introduced into the main chamber 100.

For example, the gas mixture may be a reactor effluent.

For example, the gas mixture may include gaseous iodine and a non-condensable gas.

For example, the non-condensable gas may include halogenated hydrocarbons. The non-condensable gas, excluding iodine vapor, may have a boiling point of 50° C. or lower.

For example, if the boiling point of the non-condensable gas is 50° C. or higher, the non-condensable gas may be dissolved in a low-temperature solvent or act as an impurity, thereby reducing the iodine recovery rate. For example, when the non-condensable gas is liquefied or desublimated, it may be difficult to separate the non-condensable gas from the solid iodine to be recovered.

For example, if the boiling point of the non-condensable gas is 50° C. or lower, iodine may be selectively recovered from the substances contained in the gas mixture, thereby improving the purity of iodine.

The temperature of the gas mixture introduced into the main chamber 100 through the inlet pipe 110 may be 150° C. to 250° C.

The gas mixture may be heated or cooled before being introduced into the inlet pipe 110. Alternatively, the inlet pipe 110 may itself be heated or cooled to increase or decrease the temperature of the gas mixture.

For example, the pressure within the main chamber 100 may be in a range of 1 atm to 3 atm. In this case, when the temperature of the gas mixture is 150° C. to 250° C., the iodine included in the gas mixture introduced into the main chamber 100 may be present in a gaseous state.

The gas mixture may be introduced into the main chamber 100 through the inlet pipe 110 to contact the main solvent contained in the main chamber 100. For example, an end of the inlet pipe 110 may be immersed in the main solvent. Thus, the gas mixture may be directly dispersed into the main solvent and brought into contact with the main solvent.

For example, the temperature of the main solvent may be 50° C. or lower.

A high-temperature gas mixture may come into contact with the main solvent having a temperature of 50° C. or lower. The gas mixture and the main solvent in contact therewith may exchange heat. The gaseous iodine included in the gas mixture may be cooled by the main solvent. The gaseous iodine may be converted into solid iodine. At least a portion of the gaseous iodine may be precipitated as solid iodine.

The end of inlet pipe 110 may be positioned within main chamber 100. For example, the end of inlet pipe 110 may be positioned at approximately the central portion of the main chamber 100 in the longitudinal direction thereof. The longitudinal direction of the main chamber 100 may be the direction parallel to the diameter thereof when main chamber 100 has a cylindrical shape. The gas mixture introduced into main chamber 100 through inlet pipe 110 may be dispersed from the central portion of the main chamber 100.

When the gas mixture is dispersed from the central portion of the main chamber 100, the gas mixture may be introduced into the main chamber 100 and contact the main solvent. Gaseous iodine included in the gas mixture may be cooled upon contact with the low-temperature main solvent and precipitated as solid iodine.

Conversely, when the gas mixture is dispersed from the wall surface of the main chamber 100, solid iodine crystals cooled and precipitated may grow from the wall surface of the main chamber 100. In this case, the solid iodine may form crystals and grow on the wall surface of the main chamber 100 rather than precipitating as fine particles. Accordingly, an internal volume of the main chamber 100 may decrease. Alternatively, the precipitated solid iodine may adhere to the wall surface of the main chamber 100, making it difficult to transfer the solid iodine to the separation chamber 200.

Gas discharge holes 111 may be formed in the inlet pipe 110. The gas mixture may be discharged from the inlet pipe 110 to the main chamber 100 through the gas discharge holes 111.

A plurality of gas discharge holes 111 may be formed in the inlet pipe 110. For example, the plurality of gas discharge holes 111 may be formed along the longitudinal direction of the inlet pipe 110. The plurality of gas discharge holes 111 may be formed along the circumferential direction of the inlet pipe 110. The plurality of gas discharge holes 111 may be formed along both the longitudinal direction and the circumferential direction of the inlet pipe 110.

The spacing between the plurality of gas discharge holes 111 may vary. By adjusting the spacing between the gas discharge holes 111, distribution of the gas mixture in the main solvent may be controlled.

For example, the spacing between the gas discharge holes 111 may decrease toward the end of the inlet pipe 110. For example, the spacing between the gas discharge holes 111 may decrease toward the central portion of the main chamber 100. Accordingly, a greater amount of the gas mixture may be discharged from the central portion of the main chamber 100 than from the wall surface thereof.

The gas mixture may be introduced into the main chamber 100 to contact the main solvent and may be cooled by the main solvent. Gaseous iodine may be precipitated as solid iodine. The gas mixture may be discharged in a large amount to approximately the central portion of the main chamber 100, and the gaseous iodine may be precipitated as solid iodine particles rather than growing as crystals on the wall surface of the main chamber 100.

A bubble generator (not shown) may be installed in the inlet pipe 110. In this case, the gas mixture including the gaseous iodine may be introduced into the main chamber 100 in the form of bubbles.

When the gas mixture is introduced in the form of bubbles, the contact area between the gas mixture and the main solvent may increase, thereby enhancing the iodine precipitation effect. Since the bubbles slowly rise or disperse within the main solvent, the contact time between the gas mixture and the main solvent may increase. Accordingly, the time required for iodine to be precipitated may be reduced.

For example, a vibrator or a sonicator may be connected to the bubble generator, by which the bubble size of the gas mixture introduced through the inlet pipe 110 may be controlled.

The bubble size of the gas mixture may be controlled such that the average bubble diameter is 1 mm or less. For example, the diameter of an end portion of the vibrator or the sonicator through which the gas mixture is discharged may be 1 mm or less.

The larger the bubbles introduced into the main chamber 100, the smaller the surface area of the gas mixture in contact with the main solvent relative to an amount of the gas mixture. Accordingly, if the bubbles are too large, iodine may not be sufficiently cooled by the main solvent to be precipitated as solid iodine, but instead may remain as gaseous iodine or as liquid iodine dissolved in the main solvent.

In addition, when the bubble size is large, buoyancy of the bubbles may increase compared to that of smaller bubbles, such that the bubbles may pass through the main solvent more rapidly. Accordingly, contact time between the iodine and the main solvent may decrease, and the iodine may not be sufficiently cooled to be precipitated as solid iodine.

For example, when the bubble size is large, an amount of iodine carried over may increase.

When the main solvent comes into contact with the gas mixture, the composition of the main solvent may change.

For example, substances other than iodine in the gas mixture may undergo phase changes upon contact with the main solvent. Substances other than iodine in the gas mixture may be liquefied or deposited as a solid upon contact with the main solvent. Alternatively, some components of the gas mixture may be dissolved in the main solvent. Some of the gaseous iodine may be dissolved in the main solvent.

For example, the main solvent may undergo a change in composition upon contact with the gas mixture. Some components of the main solvent may be vaporized.

The separation chamber 200 may be connected to the main chamber 100.

Iodine precipitated in the main chamber 100 may be discharged from the main chamber 100 together with the main solvent and transferred to the separation chamber 200.

The separation chamber 200 may be disposed below the main chamber 100. The precipitated iodine and the main solvent may be transferred to the separation chamber 200 by gravity.

In the separation chamber 200, the iodine precipitated in the main chamber 100 may be separated from the main solvent.

For example, a filter (not shown) may be installed in the separation chamber 200. The filter may be configured so that the main solvent introduced into the separation chamber 200 may pass through the filter, while the precipitated iodine may be retained by the filter. The precipitated iodine may thereby be separated from the main solvent by the filter.

For example, the filter may be installed so as to be inclined downward within the separation chamber 200. The separated iodine may move along the inclined surface of the filter under force of gravity and may be easily recovered from the separation chamber 200.

For example, in the separation chamber 200, the precipitated iodine and the main solvent may be separated from each other by centrifugation. The main solvent and the precipitated iodine introduced into the separation chamber 200 may be subjected to centrifugation in the separation chamber 200. Accordingly, the main solvent and the precipitated iodine introduced into the separation chamber 200 may be separated from each other.

For example, the precipitated iodine and the main solvent may be subjected to heat treatment in the separation chamber 200 to be separated from each other. The main solvent and the precipitated iodine introduced into the separation chamber 200 may be subjected to heat treatment in the separation chamber 200. Accordingly, the main solvent and the precipitated iodine introduced into the separation chamber 200 may be separated from each other.

For example, the iodine recovery apparatus may further include a sensor unit (400), and the sensor unit (400) may include a first sensor (410) and a second sensor (420). For example, a first sensor 410 may be connected to the separation chamber 200. For example, the first sensor 410 may be a temperature sensor. The first sensor 410 may measure a temperature of the main solvent introduced into the separation chamber 200.

After measuring the temperature of the main solvent and the precipitated iodine by the first sensor 410, the control unit 500 may control heating of the main solvent and the precipitated iodine introduced into the separation chamber 200 based on the measured temperature.

For example, the control unit 500 may operate a heat treatment unit 700. The heat treatment unit 700 may heat the separation chamber 200. The heat treatment unit 700 may heat the main solvent contained in the separation chamber 200.

For example, the heat treatment unit 700 may receive a signal from the control unit 500 and heat the separation chamber 200 to approximately 100° C. to distill the main solvent. The heat treatment unit 700 may heat and distill the main solvent introduced into the separation chamber 200. As described above, the boiling point of the main solvent may be 100° C. or lower. The precipitated iodine may remain in a solid state at 100° C. within a range of 1 atm to 3 atm.

When the separation chamber 200 or the main solvent contained in the separation chamber 200 is heated to 100° C., the main solvent may be distilled, and the precipitated iodine may remain in a solid particle state. In this manner, the precipitated iodine may be separated from the main solvent by distillation of the main solvent. The main solvent introduced into the separation chamber 200 may be distilled within the separation chamber 200. Accordingly, among the main solvent and the precipitated iodine introduced into the separation chamber 200, the precipitated iodine may be separated as the main solvent is distilled.

As an alternative, the heat treatment unit 700 may receive a signal from the control unit 500 and heat the separation chamber 200 to 120° C. to 150° C. The heat treatment unit 700 may heat the main solvent and iodine introduced into the separation chamber 200. In this case, the precipitated iodine may be converted into liquid iodine.

The main solvent and the liquid iodine introduced into the separation chamber 200 may be subjected to liquid-liquid separation utilizing a density difference therebetween, thereby separating the liquid iodine from the main solvent for recovery. The liquid iodine may have a higher density than the main solvent. The liquid iodine may coexist with the main solvent without mixing therewith. For example, due to the density difference between the liquid iodine and the main solvent, the liquid iodine may be positioned at a lower portion, while the main solvent may be positioned at an upper portion. Since the liquid iodine does not mix with the main solvent, the liquid iodine may be separated and recovered by liquid-liquid separation.

The iodine separated in the separation chamber 200 may be transferred to a recovery chamber (not shown) and recovered.

The recovery chamber may be connected to the separation chamber 200. The iodine separated from the main solvent in the separation chamber 200 may be recovered in the recovery chamber.

As described above, when the filter is installed in the separation chamber 200, the precipitated iodine remaining on the filter may be transferred to the recovery chamber. For example, when the filter is installed so as to be inclined downward toward the recovery chamber, the precipitated iodine may be transferred from the separation chamber 200 to the recovery chamber by gravity and may be recovered therein.

The iodine may alternatively be recovered in the separation chamber 200 without being transferred to the recovery chamber.

For example, when the main solvent is distilled in the separation chamber 200, only solid iodine may remain in the separation chamber 200, and the solid iodine may be recovered in the separation chamber 200.

The iodine recovery apparatus according to an embodiment may further include a circulation pipe 300 and a cooler 600.

The circulation pipe 300 may connect the separation chamber 200 and the main chamber 100.

The main solvent separated from the precipitated iodine in the separation chamber 200 may be supplied to the main chamber 100 through the circulation pipe 300.

A pump (not shown) may be connected to the circulation pipe 300 to supply the main solvent within the separation chamber 200 to the main chamber 100.

The cooler 600 may be connected to the circulation pipe 300. The cooler 600 may cool the main solvent moving through the circulation pipe 300.

A second sensor 420 may be connected to the circulation pipe 300. For example, the second sensor 420 may be a temperature sensor. The second sensor 420 may measure the temperature of the main solvent moving through the circulation pipe 300. The control unit 500 may receive the temperature of the main solvent from the second sensor 420 and control operation of the cooler 600 based on the measured temperature.

The main solvent supplied into the main chamber 100 through the circulation pipe 300 may be supplied to the main chamber 100 at a reduced temperature by the cooler. The cooled main solvent may contact gaseous iodine in the main chamber 100. The gaseous iodine may be cooled and precipitated upon contact with the main solvent.

For example, the cooler 600 may reduce the temperature of the main solvent supplied to the main chamber 100 to 50° C. or lower. Operation of the cooler 600 may be controlled by the control unit 500. The control unit 500 may receive the temperature of the main solvent from the second sensor 420 and control operation of the cooler 600 such that the main solvent is cooled.

The temperature of the main solvent supplied to the main chamber 100 may be 50° C. or lower.

This is because, due to the characteristics of iodine vapor pressure, when the temperature exceeds 50° C., the iodine vapor pressure may rapidly increase, which may result in iodine loss (I₂ loss).

A gas outlet 120 may be formed at the upper portion of the main chamber 100.

The gas mixture may contact the main solvent, and its composition may partially change. For example, iodine included in the gas mixture may be dissolved in the main solvent upon contact with the main solvent. Gaseous iodine may be liquefied or precipitated upon contact with the main solvent. Components other than iodine included in the gas mixture may also be dissolved, liquefied, or sublimed upon contact with the main solvent.

Some components of the main solvent may also vaporize upon contact with the gas mixture.

After the gas mixture and the main solvent contact each other, the main solvent and the gas mixture may remain within the main chamber 100. The gas mixture remaining in the main chamber 100 may be discharged from the main chamber 100 through the gas outlet 120 positioned at the upper portion of the main chamber 100.

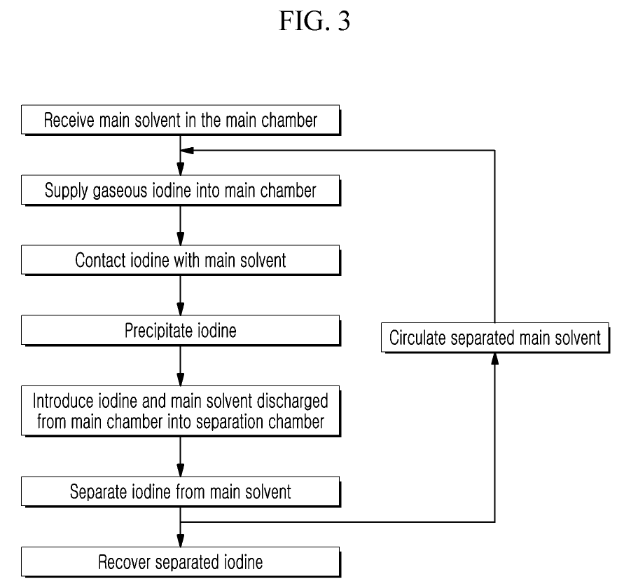

Hereinafter, an iodine recovery process that may be performed using the iodine recovery apparatus according to an embodiment of the present disclosure will be described with reference to FIG. 3.

The main solvent may be supplied and received in the main chamber 100. The temperature of the main solvent supplied to the main chamber 100 may be 50° C. or lower.

The inlet pipe 110 may be installed on one side of the main chamber 100. A gas mixture including gaseous iodine may be introduced into the main chamber 100 through the inlet pipe 110.

The inlet pipe 110 may be installed at a position lower than the level of the surface of the main solvent. The gas mixture may be introduced into the main solvent.

The gas mixture may be introduced into the main chamber 100 and may come into contact with the main solvent. The gas mixture may be heated to 150° C. to 250° C. before being introduced into the main chamber 100. For example, the gas mixture may be heated and introduced into the inlet pipe 110. For example, the inlet pipe 110 may be heated to increase the temperature of the gas mixture.

High-temperature iodine introduced through the inlet pipe 110 may be cooled upon contact with the low-temperature main solvent in the main chamber 100 and may be precipitated as solid iodine.

The precipitated iodine and the main solvent may be discharged from the main chamber 100. The discharged iodine and main solvent may be transferred to the separation chamber 200. For example, the separation chamber 200 may be positioned at a lower level than the main chamber 100. The iodine and main solvent may be transferred from the main chamber 100 to the separation chamber 200 by gravity.

In the separation chamber 200, the precipitated iodine and the main solvent may be separated from one another.

For example, a filter may be installed in the separation chamber 200. The filter may be configured so that the main solvent may pass through the filter, and the precipitated iodine may be retained by the filter, thereby separating the precipitated iodine from the main solvent. As an alternative embodiment for separation, the precipitated iodine and the main solvent may be separated from each other by centrifugation.

As another alternative for separation, in the separation chamber 200, the main solvent and the precipitated iodine may be subjected to heat treatment to be separated from each other.

For example, the first sensor 410 may be connected to the separation chamber 200. The first sensor 410 may measure the temperature of the main solvent within the separation chamber 200.

The control unit 500 may operate the heat treatment unit 700 to distill the main solvent contained in the separation chamber 200. By distilling the main solvent, the main solvent and the precipitated iodine may be separated.

As a further alternative for separation, the control unit 500 may operate the heat treatment unit 700 to heat the main solvent and the precipitated iodine contained in the separation chamber 200. The precipitated iodine may be converted into liquid iodine. By utilizing a density difference between the main solvent and the liquid iodine, the main solvent and the liquid iodine may be separated. For example, the main solvent and the liquid iodine may be separated by performing liquid-liquid separation.

Following such separation, the iodine separated from the main solvent in the separation chamber 200 may be transferred from the separation chamber 200 to the recovery chamber. Alternatively, the iodine separated from the main solvent in the separation chamber 200 may be recovered in the separation chamber 200.

The main solvent separated from the iodine in the separation chamber 200 may move through the circulation pipe 300 and be supplied to the main chamber 100.

The main solvent may be transferred from the main chamber 100 to the separation chamber 200 and then be supplied back to the main chamber 100. For example, the main solvent may be circulated from the main chamber 100 through the separation chamber 200 and back to the main chamber 100.

The main solvent may be circulated while being cooled by the cooler 600.

The second sensor 420 may be connected to the circulation pipe 300. For example, the second sensor 420 may be a temperature sensor. The second sensor 420 may measure the temperature of the main solvent moving through the circulation pipe 300. The control unit 500 may receive the temperature of the main solvent moving through the circulation pipe 300 from the second sensor 420. The control unit 500 may operate the cooler such that the temperature of the main solvent is cooled to 50° C. or lower. The cooler may reduce the temperature of the main solvent supplied to the main chamber 100 to 50° C. or lower. The main solvent may be cooled to 50° C. or lower and supplied to the main chamber 100.

A gas mixture including gaseous iodine may be continuously supplied to the main chamber 100. The main solvent may be cooled and circulated to the main chamber 100 through the circulation pipe 300. The gas mixture may come into contact with the circulating main solvent. The gaseous iodine may be cooled and precipitated upon contact with the main solvent. The precipitated iodine may be separated from the main solvent in the separation chamber 200, such that iodine may be continuously recovered.

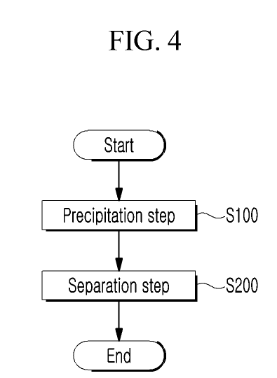

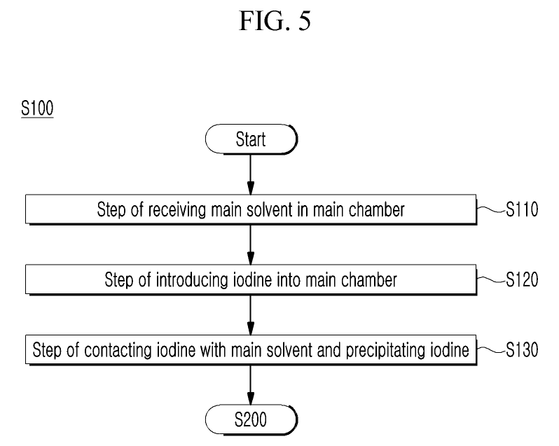

Hereinafter, an iodine recovery method according to an embodiment will be described with reference to FIGS. 4-6. Descriptions overlapping with those of the iodine recovery apparatus according to an embodiment will be omitted.

The iodine recovery method according to an embodiment may include a precipitation step (S100) and a separation step (S200).

In the precipitation step (S100), the main solvent may be contained in the main chamber 100 (S110). The gaseous mixture including gaseous iodine may be introduced into the main chamber 100 (S120). In the main chamber 100, the iodine may be cooled upon contact with the main solvent and precipitated (S130). A detailed description thereof is omitted since it has been described above.

As described above, in the precipitation step (S100), the gas mixture including the gaseous iodine may be introduced into the main chamber 100 in the form of bubbles.

After iodine is precipitated in the precipitation step (S100), the iodine and main solvent may be transferred from the main chamber 100 to the separation chamber 200.

In the separation step (S200), the iodine and main solvent moved into the separation chamber 200 may be separated from one another. For example, as described above, the filter may be installed in the separation chamber 200. Alternatively, centrifugation may be performed to separate the iodine from the main solvent. Alternatively, the heat treatment unit 700 may heat-treat the separation chamber 200 or the main solvent to separate the iodine from the main solvent. Since the method for separating the iodine and main solvent has been described above, a detailed description will be omitted.

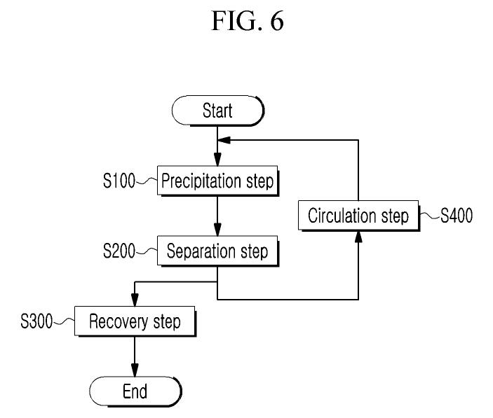

Referring to FIG. 6, the iodine recovery method according to an embodiment of the present disclosure may further include a recovery step (S300) and a circulation step (S400) after the separation step (S200).

In the recovery step (S300), iodine separated from the main solvent in the separation chamber 200 may be recovered. For example, the iodine separated from the main solvent and remaining in the separation chamber 200 may be recovered. Alternatively, the iodine separated from the main solvent may be transferred to the recovery chamber and be recovered.

For example, the liquid iodine separated from the main solvent may be recovered. The iodine contained in the separation chamber 200 may be recovered. Alternatively, the iodine may be transferred to the recovery chamber and recovered therein.

In the circulation step (S400), the main solvent separated from the iodine in the separation step (S200) may be supplied to the main chamber 100. The circulation pipe 300 may connect the main chamber 100 and the separation chamber 200. The main solvent may be circulated from the separation chamber 200 to the main chamber 100 through the circulation pipe 300.

As described above, the cooler 600 may be connected to the circulation pipe 300. The main solvent discharged from the separation chamber 200 may be cooled by the cooler 600 and supplied to the main chamber 100.

While the preferred embodiments of the present invention have been described in detail above, the scope of the present disclosure is not limited thereto. Various modifications and improvements made by those skilled in the art, utilizing the basic concepts of the present disclosure, also fall within the scope of the present disclosure.

What is claimed is:

1. An iodine recovery apparatus comprising:
a main chamber containing a main solvent; and
an inlet pipe connected to the main chamber, the inlet pipe being configured to introduce iodine in a gaseous state into the main chamber,
wherein the main chamber is configured so that the iodine in a gaseous state is cooled upon contact with the main solvent and precipitated as solid iodine.

2. The iodine recovery apparatus according to claim 1, further comprising a separation chamber configured to:
receive the solid iodine and the main solvent discharged from the main chamber; and
separate the solid iodine from the main solvent.

3. The iodine recovery apparatus according to claim 2, further comprising a circulation pipe configured to supply the main solvent separated in the separation chamber to the main chamber.

4. The iodine recovery apparatus according to claim 3, further comprising a cooler connected to the circulation pipe, the cooler being configured to cool the main solvent supplied to the main chamber from the separation chamber.

5. The iodine recovery apparatus according to claim 4, wherein the cooler is configured to cool the main solvent supplied to the main chamber to a temperature of 50° C. or lower.

6. The iodine recovery apparatus according to claim 2, wherein the separation chamber further comprises a filter, the filter being configured to allow the main solvent introduced into the separation chamber to pass therethrough and prevent the solid iodine from passing therethrough.

7. The iodine recovery apparatus according to claim 1, wherein an end portion of the inlet pipe is positioned within the main chamber.

8. The iodine recovery apparatus according to claim 7, wherein a portion of the inlet pipe disposed within the main chamber includes gas discharge holes configured to discharge a gas mixture containing the iodine in a gaseous state.

9. The iodine recovery apparatus according to claim 8, wherein the inlet pipe comprises a plurality of the gas discharge holes.

10. The iodine recovery apparatus according to claim 9, wherein spacings between the plurality of gas discharge holes are different from each other.

11. The iodine recovery apparatus according to claim 9, wherein the spacing between the plurality of gas discharge holes decreases toward an end of the inlet pipe.

12. The iodine recovery apparatus according to claim 8, wherein the inlet pipe further comprises a bubble generator configured to form bubbles of the gas mixture containing the iodine in a gaseous state introduced into the main chamber.

13. The iodine recovery apparatus according to claim 1, wherein the iodine recovery apparatus is further configured so that a temperature of the gas mixture introduced through the inlet pipe is in a range of 150° C. to 250° C.

14. The iodine recovery apparatus according to claim 2, wherein the separation chamber is further configured to heat the main solvent and the solid iodine introduced into the separation chamber, thereby separating the main solvent and the solid iodine from each other.

15. The iodine recovery apparatus according to claim 14, wherein the separation chamber is further configured to distill the main solvent introduced into the separation chamber through the heating of the main solvent and the solid iodine.

16. The iodine recovery apparatus according to claim 14, wherein the separation chamber is further configured to heat the main solvent and the solid iodine such that the solid iodine is converted into liquid iodine, and
wherein the separation chamber further comprises a liquid-liquid separator configured to receive the main solvent and the liquid iodine introduced into the separation chamber and subject the main solvent and the liquid iodine to liquid-liquid separation, thereby recovering the liquid iodine.

17. An iodine recovery method comprising:
introducing gaseous iodine into a main chamber containing a main solvent; and
cooling the gaseous iodine upon contact with the main solvent to precipitate the iodine as solid iodine.

18. The iodine recovery method according to claim 17, further comprising:
transferring the solid iodine and the main solvent discharged from the main chamber into a separation chamber; and
separating the solid iodine from the main solvent in the separation chamber.

19. The iodine recovery method according to claim 18, wherein the gaseous iodine is introduced into the main chamber as a gas mixture including the gaseous iodine, and wherein the gas mixture is introduced into the main chamber as bubbles.

20. The iodine recovery method according to claim 18, further comprising:
cooling the main solvent after separating the solid iodine from the main solvent, and
supplying the cooled main solvent to the main chamber.
